(19) United States
(12) Patent Application Publication
(10) Pub. No.: US 2012/0076300 A1
(43) Pub. Date: Mar. 29, 2012

(54) KEY INFORMATION MANAGEMENT METHOD, CONTENT TRANSMISSION METHOD, KEY INFORMATION MANAGEMENT APPARATUS, LICENSE MANAGEMENT APPARATUS, CONTENT TRANSMISSION SYSTEM, AND TERMINAL APPARATUS

(75) Inventors: Motoyuki Uchida, Kanagawa (JP); Koji Ishii, Kanagawa (JP); Toshio Kaneda, Kanagawa (JP)

(73) Assignee: NTT DOCOMO, INC., Tokyo (JP)

(21) Appl. No.: 13/260,810

(22) PCT Filed: Mar. 11, 2010
(86) PCT No.: PCT/JP10/54125

§ 371 Date: Nov. 8, 2011

(30) Foreign Application Priority Data
Mar. 30, 2009 (JP) 2009-081793

(51) Int. Cl. H04L 9/14; H04L 9/08

(52) U.S. Cl. 380/255; 380/44

(57) ABSTRACT

The present invention aims to reliably prevent illegal use of content when the content is encrypted and transmitted with a cipher key. A content transmission method of the present invention includes: a basic key creating step of creating a basic key K₁; a cipher key creating step of creating a cipher key Kₙ and also creating mutual cipher keys K₂ through Kₙ₋₁; a first key encrypting step of encrypting the mutual cipher key K₂ with the basic key K₁, a second key encrypting step of encrypting the mutual cipher keys K₃ through Kₙ₋₁ and the cipher key Kₙ by successively using the keys K₂ through Kₙ₋₁; a content encrypting step of encrypting content C with the cipher key Kₙ; a first transmitting step of transmitting content Kₙ (C) and one part among key data K₁ (K₂), . . . , Kₙ₋₁ (Kₙ) to a terminal apparatus 2 through a broadcast wave; and a second transmitting step of transmitting another part among the key data K₁ (K₂), . . . , Kₙ₋₁ (Kₙ) to the terminal apparatus 2 through a communication network.

### TECHNICAL FIELD

The present invention relates to a key information management method, a content transmission method, a key information management apparatus, a license management apparatus, a content transmission system, and a terminal apparatus.

### BACKGROUND ART

Conventionally, there is a widely used technology of encrypting electronic content such as music content and video content and transmitting through a communication network and a broadcast network. For example, Patent Literature 1 mentioned below discloses an encryption communication system where plaintext data is encrypted and transmitted; a part of a cipher key is previously stored both at an encrypting side and a decrypting side; and the rest of the cipher key is transmitted through the communication network. In addition, Patent Literature 2 mentioned below discloses an apparatus for receiving an encrypted first key to encrypt content through the communication network; for using a recording medium to obtain a second key; and thereafter, for decrypting the first key with the second key.

### CITATION LIST

### Patent Literature

[Patent Literature 1] Japanese Patent Application Laid-Open Publication No. 2004-341744

[Patent Literature 2] Japanese Patent Application Laid-Open Publication No. 2005-303873

### SUMMARY OF INVENTION

### Technical Problem

In any of the above-mentioned apparatuses, however, there is the risk that key data to encode content is directly illegally acquired during transmission and there is a problem that once the apparatus at a decoding side is hacked and a key previously stored is illegally acquired, the content becomes illegally available to be used.

The present invention has been made in view of the above problems and aims to provide a key information management method, a content transmission method, a key information management apparatus, a license management apparatus, a content transmission system and a terminal apparatus which are capable of reliably preventing illegal use of content, when the content is encrypted and transmitted with a cipher key.

### Solution to Problem

In order to solve the problems described above, a key information management method of the present invention is a key information management method for encrypting and transmitting content to a terminal apparatus and includes: a basic key creating step of, by basic key management means, creating a basic key; and a key encrypting step of, by the basic key management means, encrypting with the basic key one piece of key reproduction data among a plurality of pieces of key reproduction data to reproduce a cipher key to encrypt the content.

In another aspect, a key information management method of the present invention is a key information management method for encrypting and transmitting content to a terminal apparatus and includes: a cipher key creating step of, by cipher key creating means, creating a cipher key to encrypt the content and also creating a plurality of pieces of key reproduction data to reproduce the cipher key; a key encrypting step of, by the cipher key creating means, encrypting another piece of key reproduction data excluding one piece of key reproduction data among the plurality of pieces of key reproduction data by successively using the one piece of key reproduction data and the other piece of key reproduction data correspondingly; and a transmitting step of, by the cipher key creating means, transmitting the one piece of key reproduction data encrypted with a specific basic key and one part of the other piece of key reproduction data encrypted at the second key encrypting step to the terminal apparatus.

In another aspect, a content transmission method of the present invention is a content transmission method for encrypting and transmitting content to a terminal apparatus and includes: a basic key creating step of, by basic key management means, creating a basic key; a cipher key creating step of, by cipher key creating means, creating a cipher key to encrypt the content and also creating a plurality of pieces of key reproduction data to reproduce the cipher key; a first key encrypting step of, by the basic key management means, encrypting one piece of key reproduction data among the plurality of pieces of key reproduction data by the basic key; a second key encrypting step of, by the cipher key creating means, encrypting another piece of key reproduction data excluding the one piece of key reproduction data among the plurality of pieces of key reproduction data by successively using the one piece of key reproduction data and the other piece of key reproduction data correspondingly; a content encrypting step of, by content encrypting means, encrypting the content with the cipher key; a first transmitting step of, by content transmitting means, transmitting the content that has been encrypted and one part among the one and the other pieces of encrypted key reproduction data to the terminal apparatus; and a second transmitting step of, by the cipher key creating means, transmitting another part among the one and the other pieces of encrypted key reproduction data to the terminal apparatus.

By the key information management method and the content transmission method, a basic key is created by the basic key management means; a cipher key and a plurality of pieces of key reproduction data to reproduce the cipher key are created by the cipher key creating means; one piece of key reproduction data is encrypted by the basic key management means with the basic key; the other piece of key creation data is encrypted by successively using the one piece of key reproduction data and the other piece of key reproduction data by the cipher key creating means; content encrypted with the cipher key and one part of the encrypted key reproduction data are transmitted to the terminal apparatus by the content transmitting means; and the other part of the key reproduction data are transmitted to the terminal apparatus by the cipher key creating means. Thereby, data to reproduce a key to decrypt content is divided, encrypted and separately transmitted and while a part thereof is encrypted with the basic key previously created, the remaining part thereof is encrypted by mutually using themselves as mutual cipher keys, therefore, it is possible to reliably reduce the risk of illegal acquirement of key information during data transmission. That is, even when a part of the key reproduction data and the basic key previously created are illegally acquired, it is possible to prevent illegal use of an encrypted key to decrypt the content.

Here, it is preferable that a plurality of mutual cipher keys are created as the plurality of pieces of key reproduction data at the cipher key creating step, a first mutual cipher key among the plurality of mutual cipher keys is encrypted with the basic key at the first key encrypting step, the cipher key and the plurality of mutual cipher keys excluding the first mutual cipher key are successively encrypted with the plurality of mutual cipher keys including the first mutual cipher key correspondingly at the second key encrypting step, the content that has been encrypted and one part among the plurality of encrypted mutual cipher keys and the cipher key are transmitted to the terminal apparatus at the first transmitting step, and another part among the plurality of encrypted mutual cipher keys and the cipher key are transmitted to the terminal apparatus at the second transmitting step.

In that case, since the plurality of encrypted mutual cipher keys and the cipher key are divided and transmitted and while a part thereof is encrypted with the basic key, the remaining part thereof is mutually encrypted, even when a part of the key reproduction data and the basic key that is previously created are illegally acquired, it is possible to prevent illegal use of an encrypted key to decrypt content. Furthermore, there is an advantage that while preventing illegal use of the content, processing to reproduce the cipher key does not become complicated.

Furthermore, it is also preferable that the cipher key is divided, so that a plurality of divided cipher keys are created as the plurality of pieces of key reproduction data at the cipher key creating step; a first divided cipher key among the plurality of divided cipher keys is encrypted with the basic key at the first key encrypting step; the plurality of divided cipher keys excluding the first divided cipher key are successively encrypted with the plurality of divided cipher keys including the first divided cipher key at the second key encrypting step; the content that has been encrypted and one part of the plurality of encrypted divided cipher keys are transmitted to the terminal apparatus at the first transmitting step; another part of the plurality of encrypted divided cipher keys is transmitted to the terminal apparatus at the second transmitting step.

In that way, since the plurality of encrypted divided cipher keys are separately transmitted and while a part thereof is encrypted by the basic key, the remaining part thereof is mutually encrypted, even when a part of key reproduction data and the basic key that is previously created are illegally acquired, it is possible to prevent illegal use of a cipher key to decrypt content. Furthermore, since there is no direct transaction of the cipher key to decrypt content, it is possible to further reduce the risk of illegal acquirement of the cipher key.

A basic key management apparatus of the present invention is a basic key management apparatus for encrypting and transmitting content to a terminal apparatus and includes: basic key creating means for creating a basic key; and key encrypting means for encrypting one piece of key reproduction data among a plurality of pieces of key reproduction data to reproduce a cipher key to encrypt the content with the basic key.

In another aspect, a license management apparatus of the present invention is a license management apparatus for encrypting and transmitting content to a terminal apparatus and includes: cipher key creating means for creating a cipher key to encrypt the content and also creating a plurality of pieces of key reproduction data to reproduce the cipher key; key encrypting means for encrypting another piece of key reproduction data excluding one piece of key reproduction data among the plurality of pieces of key reproduction data by successively using the one piece of key reproduction data and the other piece of key reproduction data correspondingly; and transmitting means for transmitting the one piece of key reproduction data encrypted with a specific basic key and one part of the other piece of key reproduction data encrypted by the key encrypting means to the terminal apparatus.

In another aspect, a content transmission system of the present invention is a content transmission system for encrypting and transmitting content to a terminal apparatus, and includes: basic key creating means for creating a basic key; cipher key creating means for creating a cipher key to encrypt the content and also creating a plurality of pieces of key reproduction data to reproduce the cipher key; first key encrypting means for encrypting one piece of key reproduction data among the plurality of pieces of key reproduction data with the basic key; second key encrypting means for encrypting another piece of key reproduction data excluding the one piece of key reproduction data among the plurality of pieces of key reproduction data by successively using the one piece of key reproduction data and the other piece of key reproduction data correspondingly; content encrypting means for encrypting the content with the cipher key; content transmission means for transmitting the content that has been encrypted and one part among the one and the other pieces of encrypted key reproduction data to the terminal apparatus; and key information transmitting means for transmitting another part among the one and the other pieces of encrypted key reproduction data to the terminal apparatus.

In another aspect, a terminal apparatus of the present invention is a terminal apparatus for receiving and decrypting encrypted content and includes: first receiving means for receiving the content that has been encrypted with a cipher key and one part of key reproduction data among a plurality of pieces of encrypted key reproduction data; second receiving means for receiving another part of key reproduction data among the plurality of pieces of encrypted key reproduction data; key decrypting means for reproducing the cipher key by decrypting one piece of key reproduction data among the plurality of pieces of encrypted key reproduction data with a basic key and, thereafter, by successively decoding the plurality of pieces of key reproduction data excluding the one piece of key reproduction data mutually using the plurality of pieces of key reproduction data, and content decrypting means for decrypting the content using the cipher key.

In such a key information management apparatus, a license management apparatus, a content transmission system and a terminal apparatus, a basic key is created by the basic key management means; a cipher key and a plurality of pieces of key reproduction data to reproduce the cipher key are created by the cipher key creating means; one piece of key reproduction data is encrypted with the basic key by the basic key management means; the other piece of key creation data is encrypted by successively using the one piece of key reproduction data and the other piece of key reproduction data by the cipher key creating means; content encrypted with the cipher key and one part of encrypted key reproduction data are transmitted to the terminal apparatus by the content transmitting means; and the other part of the key reproduction data is transmitted to the terminal apparatus by the cipher key creating means. Thereby, data to reproduce a key to decrypt content is divided, encrypted and separately transmitted and while a part thereof is encrypted with the basic key previously created, the remaining part thereof is encrypted by mutually using themselves as cipher keys, therefore, it is possible to reliably reduce the risk that key information is illegally acquired during data transmission. That is, even when a part of the data to reproduce a key and the basic key previously created are illegally acquired, it is possible to prevent illegal use of an encrypted key to decrypt the content.

### ADVANTAGEOUS EFFECTS OF INVENTION

According to the present invention, in the case of transmitting content encrypted with a cipher key, it is possible to reliably prevent illegal use of the content.

### BRIEF DESCRIPTION OF DRAWINGS

FIG. 1 is a connection configuration diagram illustrating a content transmission system and a terminal apparatus according to a preferable embodiment of the present invention.

FIG. 2 is a block diagram illustrating a hardware configuration of each server in the content transmission system of FIG. 1.

FIG. 3 is a block diagram illustrating a hardware configuration of the terminal apparatus in FIG. 1.

FIG. 4 is a block diagram illustrating a functional configuration of a license server in FIG. 1.

FIG. 5 is a block diagram illustrating a functional configuration of a basic key management server in FIG. 1.

FIG. 6 is a block diagram illustrating a functional configuration of a content provision server in FIG. 1.

FIG. 7 is a block diagram of a functional configuration of the terminal apparatus in FIG. 1.

FIG. 8 is a sequence diagram illustrating operation of the content transmission system in FIG. 1.

FIG. 9 is a conceptual diagram illustrating a flow of encrypting processing and decrypting processing of a cipher key to encrypt content according to the content transmission system in FIG. 8.

FIG. 10 is a sequence diagram illustrating operation of the content transmission system according to a modification of the present invention.

FIG. 11 is a conceptual diagram illustrating a flow of an encrypting processing and a decrypting processing of the cipher key to encrypt content according to the content transmission method in FIG. 10.

### DESCRIPTION OF EMBODIMENTS

With reference of drawings, preferable embodiments of the content transmission system, the content transmission method and the terminal apparatus of the present invention will be described into detail. In the description of the drawings, the same reference sign is given to the same element and redundant explanation is omitted.

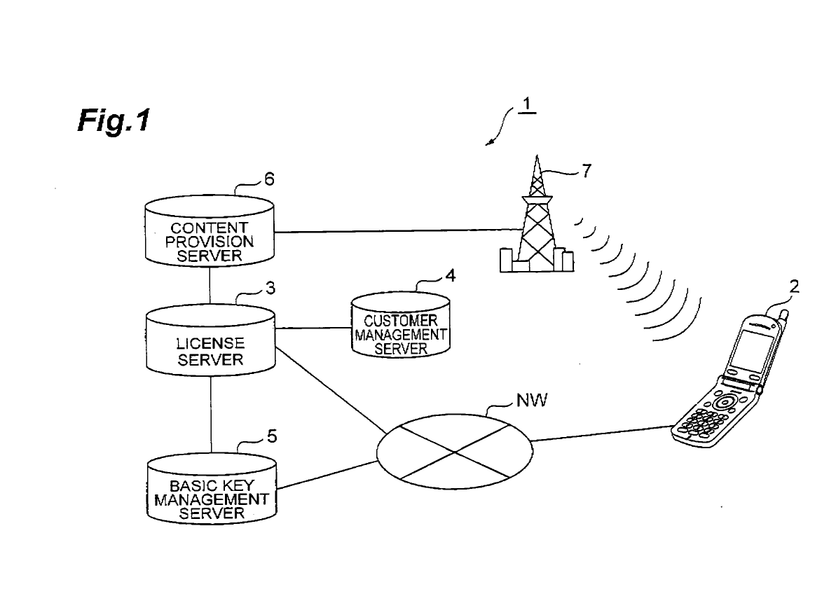

FIG. 1 is a connection configuration diagram illustrating a content transmission system 1 and a terminal apparatus 2 according to a preferable embodiment of the present invention. The terminal apparatus illustrated in the diagram is a mobile terminal such a cellular phone, a personal digital assistance (PDA), and the like and an information processing terminal such as a personal computer. The content transmission system 1 is a group of servers for acquiring content such as music data, image data and the like from an external network and a recording medium; and for encrypting the content and delivering it on a broadcast wave to the terminal apparatus 2.

The content transmission system 1 is consisted of a license server (license management apparatus) 3 for creating and managing a cipher key to encrypt content; a customer management server 4 for managing customer information on a user of the terminal apparatus 2; a basic key management server (basic key management apparatus) 5 for managing a basic key to encrypt data to reproduce the cipher key; and a content provision server 6 for delivering content. The license server 3, the customer management server 4, the basic key management server 5 and the content provision server 6 are mutually connected to one another to be capable of data communication through a network such as a LAN and a WAN. Additionally, the content provision server 6 is connected to a broadcast wave relay station 7 to be capable of delivering data on a broadcast wave to the terminal apparatus 2, while the basic key management server 5 and the license server 3 are connected to a communication network NW to be capable of transmitting data through a data communication network to the terminal apparatus 2. Here, the license server 3, the customer management server 4 and the basic key management server 5 and the content provision server 6 may be placed in the same location or any of them may be placed in another location.

Next, a configuration of each server of the content transmission system 1 and the terminal apparatus 2 will be described in detail.

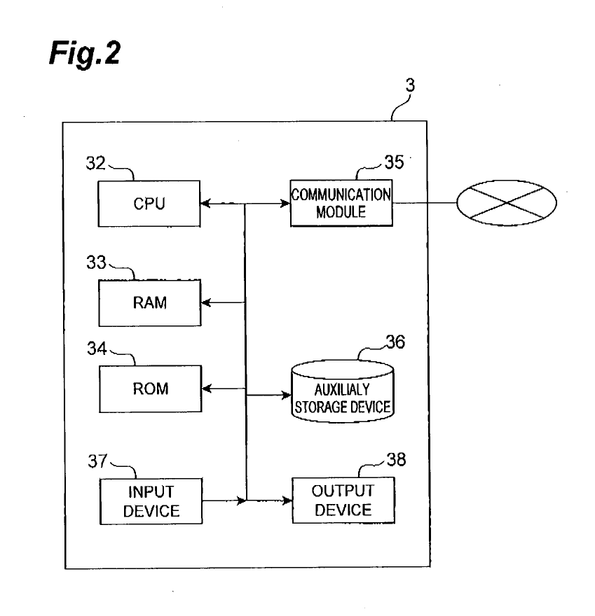

As illustrated in FIG. 2, the license server 3 of the content transmission system 1 is physically configured as an information processing equipment that includes a CPU 32; a main storage device such as a RAM 33 and a ROM 34; an auxiliary storage device 36 such as a hard disk device and the like; an input device 37 such as an input device including an input key, a mouse and the like; an output device 38 such as a display and the like; a communication module 35 for controlling data transmission and data reception with another server apparatus, the broadcast wave relay station 7 and the communication network NW. A function to be achieved by the license server 3 is achieved by loading a given program into hardware such as the CPU 32, the RAM 33 and the like as illustrated in FIG. 2 to operate the communication module 35, the input device 37 and the output device 38 under the control of the CPU 32 and to read out and write in data in the RAM 33 and the auxiliary storage device 36. Additionally, the hardware of the other server apparatuses in the content transmission system 1 is also configured in the similar way, so the explanation is omitted.

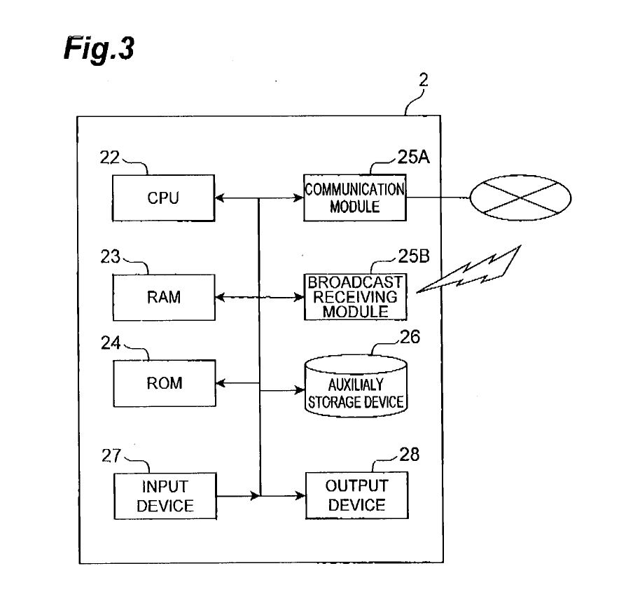

As illustrated in FIG. 3, the terminal apparatus 2 is physically configured as an information processing terminal that includes a CPU 22; a main storage device such as a RAM 23 and a ROM 24; an auxiliary storage device 26 such as a hard disk device, a memory card and the like; an input device 27 such as an input device including an input key, a microphone and the like; an output device 28 such as a speaker, a display and the like; a communication module 25A for controlling data transmission and data reception with the communication network NW; a broadcast receiving module 25B for controlling broadcast wave reception; and the like. A function to be achieved by the terminal apparatus 2 is achieved by loading a given program into hardware such as the CPU 22, the RAM 23 and the like as illustrated in FIG. 3 to operate the communication module 25A, the broadcast receiving module 25B, the input device 27 and the output device 28 under the control of the CPU 22 and to read out and write in data in the RAM 23 and the auxiliary storage device 26.

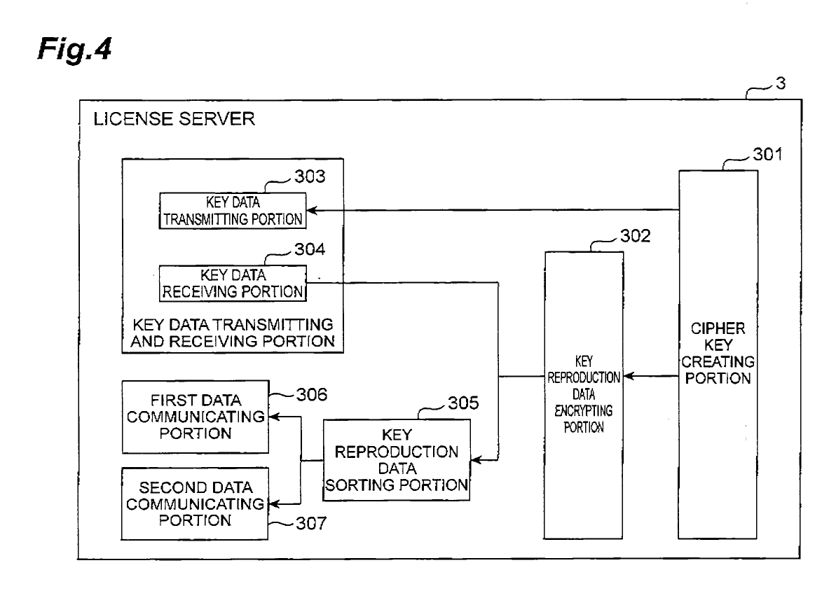

As illustrated in FIG. 4, the license server 3 includes, as functional configuration elements, a cipher key creating portion (cipher key creating means) 301, a key reproduction data encrypting portion (key encrypting means) 302, a key data transmitting portion 303, a key data receiving portion 304, a key reproduction data sorting portion 305, a first data communicating portion (transmitting means) 306, and a second data communicating portion 307.

Based on customer information on a user of the terminal apparatus 2 that is acquired from the customer management server 4, the cipher key creating portion 301 has a function to create a cipher key Kₙ (n is an integer equal to or larger than four) to encrypt content in a common key encryption method and a function to create a plurality of pieces of key reproduction data for reproducing the cipher key Kₙ at a terminal apparatus 2 side. Specifically, the cipher key creating portion 301 creates a plurality of mutual cipher keys K₂ through Kₙ₋₁ as the key reproduction data. The cipher key Kₙ needs at least one key data, but a plurality of pieces of key data may be created depending on a protection level of the content. Then, the cipher key creating portion 301 outputs the mutual cipher key K₂ among the plurality of created mutual cipher keys K₂ through Kₙ₋₁ to the key data transmitting portion 303 and outputs the mutual cipher keys K₂ through Kₙ₋₁ and the cipher key Kₙ to the key reproduction data encrypting portion 302.

The key data transmitting portion 303 transmits the mutual cipher key K₂ received from the cipher key creating portion 301 to the basic key management server 5. Meanwhile, the key data receiving portion 304 receives a mutual cipher key K₁ (K₂) encrypted with the basic key K₁ from the basic key management server 5 and outputs to the key reproduction data sorting portion 305. Hereinafter, “K_{X} (K_{Y})” represents a key K_{Y} encrypted with a key K_{X} in the common key encryption method.

The key reproduction data encrypting portion 302 encrypts a cipher key Kₙ and mutual cipher keys K₃ through Kₙ₋₁ excluding the mutual cipher key K₂ by successively using mutual cipher keys K₂ through Kₙ₋₁ correspondingly and creates encrypted data K₂ (K₃), K₃ (K₄), . . . , Kₙ₋₁ (Kₙ). Here, the key reproduction data encrypting portion 302 is also capable of converting any or all of the mutual cipher keys K₂ through Kₙ₋₁ and the cipher key Kₙ by using any conversion algorism, depending on a security level, into data of which key data itself is unable to be analyzed. In that case, the key reproduction data encrypting portion 302 performs data conversion before encrypting processing and embeds additional information to notify the terminal apparatus 2 of the conversion algorism in resulting data after the data conversion. In addition, to that additional information, information to be used for successively decrypting the mutual cipher keys K₃ through Kₙ₋₁ and the cipher key Kₙ, such as information to check for falsification of a key next to be used, information indicating a key number and the like may be added. Furthermore, the key reproduction data encrypting portion 302 outputs the encrypted data K₂ (K₃), K₃ (K₄), . . . , Kₙ₋₁ (Kₙ), and the cipher key Kₙ to the key reproduction data sorting portion 305.

The key reproduction data sorting portion 305 has a function to sort the encrypted mutual cipher keys K₁ (K₂), K₂ (K₃), . . . , Kₙ₋₂ (Kₙ₋₁), and the cipher key Kₙ₋₁ (Kₙ) for each transmission destination. That is, the key reproduction data sorting portion 305 selects, as a part of the above-mentioned key K₁ (K₂), . . . , Kₙ₋₁ (Kₙ), the mutual cipher key K₁ (K₂) and keys to be transmitted through the communication network NW to the terminal apparatus 2 and sorts the keys into the first data communicating portion 306. Moreover, the key reproduction data sorting portion 305 selects the remaining other part of the above-mentioned key K₂ (K₃), . . . , Kₙ₋₁ (Kₙ), as keys to be transmitted through a broadcast wave to the terminal apparatus 2, and sorts the keys and the cipher key Kₙ together into the second data communicating portion 307. As a standard for sorting here, examples of applicable methods include a fixedly allocating method; a dynamically managing method, in which traffic of the communication network and the broadcast wave are monitored and when it is desired to allocate content transmission more to a band of the broadcast wave, key data transmission is to be allocated more to a communication network side; or a randomly allocating method.

The first data communicating portion 306 transmits the mutual cipher key K₁ (K₂) and the keys to be transmitted through the communication network NW, through the communication network NW to the terminal apparatus 2. Moreover, the second data communicating portion 307 transmits the cipher key Kₙ and the keys to be transmitted through the broadcast wave to the terminal apparatus 2, to the content provision server 6.

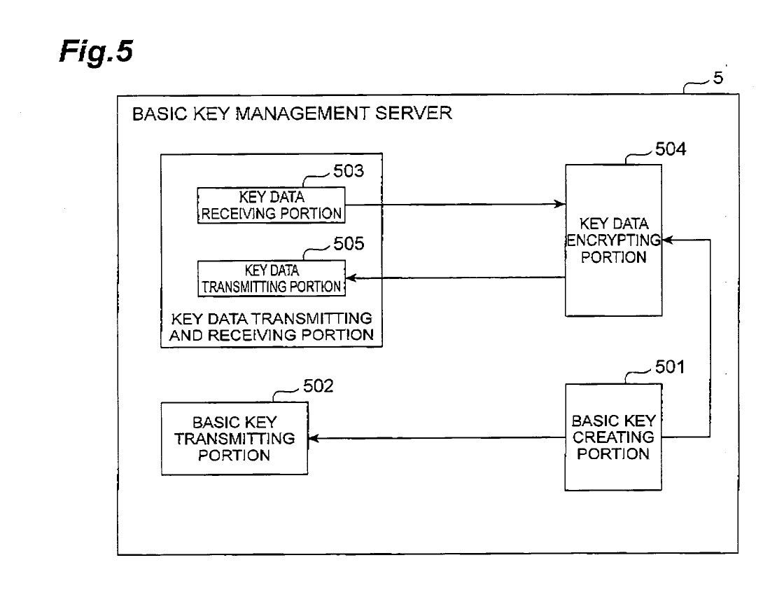

As illustrated in FIG. 5, the basic key management server 5 is configured to include a basic key creating portion (basic key creating means) 501, a basic key transmitting portion 502, a key data receiving portion 503, a key data encrypting portion (key encrypting means) 504, and a key data transmitting portion 505.

The basic key creating portion 501 creates a basic key K₁ that is key data necessary for the terminal apparatus 2 to receive provision of a broadcast service. Moreover, the basic key creating portion 501 outputs the created basic key K₁ to the basic key transmitting portion 502 and the key data encrypting portion 504, and in order to share with the terminal apparatus 2, the basic key transmitting portion 502 transmits the basic key K₁ to the terminal apparatus 2. Here, examples of transmission method to the terminal apparatus 2 include, in addition to a transmission method through the communication network NW to the terminal apparatus 2; a method for outputting to a recording medium such as an IC card and the like and then loading through the recording medium in the terminal apparatus 2; and a method for first transmitting to an information processing terminal such as a personal computer and the like and then relaying from the information processing terminal to the terminal apparatus 2 through a recording medium and short-distance wireless communication such as infrared communication, bluetooth communication and the like.

The key data receiving portion 503 receives the mutual cipher key K₂ from the license server 3 and the key data encrypting portion 504 encrypts the mutual cipher key K₂ with the basic key K₁ in the common key encryption and creates encrypted data K₁ (K₂). Then, the key data transmitting portion 505 sends the encrypted data K₁ (K₂) created by the key data encrypting portion 504 back to the license server 3.

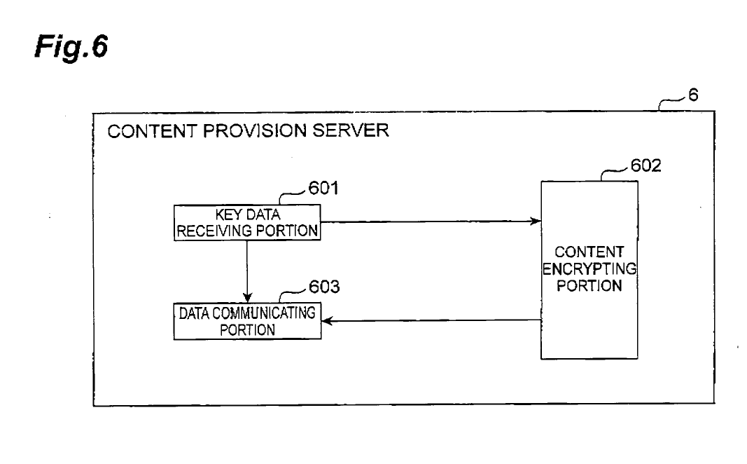

As illustrated in FIG. 6, the content provision server 6 is configured to include a key data receiving portion 601, a content encrypting portion 602 and a data communicating portion 603.

The key data receiving portion 601 receives the cipher key Kₙ; and the keys to be transmitted through the broadcast wave to the terminal apparatus 2 among the encrypted key K₂ (K₃), . . . , Kₙ₋₁ (Kₙ); from the license server 3 and outputs the keys to both a content encrypting portion 602 and a data communicating portion 603.

The content encrypting portion 602 encrypts content C to be transmitted to the terminal apparatus 2 with the cipher key Kₙ and creates encrypted data Kₙ (C). Moreover, the data communicating portion 603 transmits the encrypted data Kₙ (C) and keys to be transmitted through the broadcast wave to the terminal apparatus 2 among the keys K₂ (K₃), . . . , Kₙ₋₁ (Kₙ), through the broadcast wave to the terminal apparatus 2. Here, the data communicating portion 603 may add the keys to be transmitted through the broadcast wave to the terminal apparatus 2 to the encrypted data Kₙ (C) and simultaneously transmit by using the same broadcast wave channel or separately transmit the keys to be transmitted through the broadcast wave to the terminal apparatus 2 in a control channel and the encrypted data Kₙ (C) in a data channel, for example. The data communicating portion 603 may also transmit additional information describing information to decrypt or reproduce content in conjunction with such transmission data. In the information to reproduce content, information to identify the content such as a content number, information to identify a terminal apparatus such as a manufacturing number of the terminal apparatus and the like, information about the number of reproduction and reproduction limit and the like may be embedded.

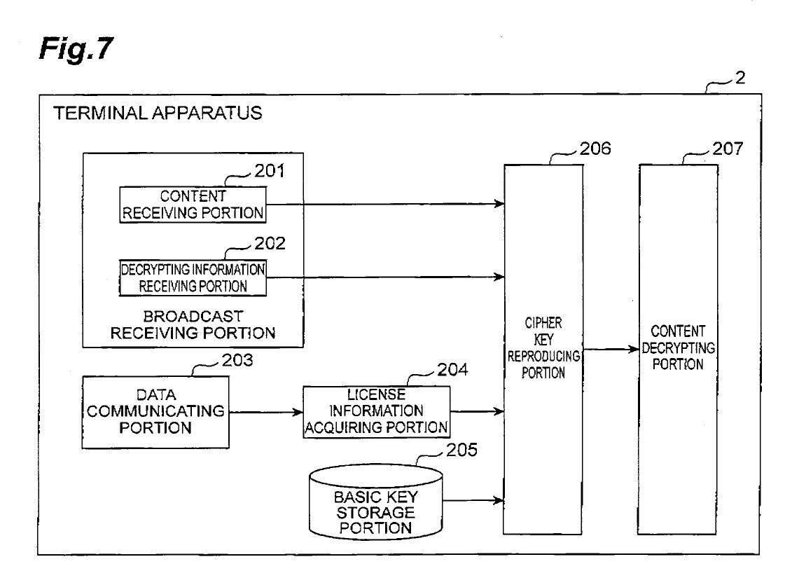

As illustrated in FIG. 7, the terminal apparatus 2 is configured to include a data communicating portion (second receiving means) 203, a license information acquiring portion (second receiving means) 204, a basic key storage portion 205, a content receiving portion (first receiving means) 201, a decrypting information receiving portion (first receiving means) 202, a cipher key reproducing portion (key decrypting means) 206 and a content decrypting portion (content decrypting means) 207.

The data communicating portion 203 receives various data through the communication network NW from the license server 3 and the basic key management server 5. Specifically, the data communicating portion 203 receives the mutual cipher key K₁ (K₂) and the keys to be transmitted through the communication network NW among the keys K₂ (K₃), . . . , Kₙ₋₁ (Kₙ) and outputs to the license information acquiring portion 204, while the license information acquiring portion 204 outputs those pieces of key data to the cipher key reproducing portion 206.

The content receiving portion 201 receives the encrypted content Kₙ (C) through the broadcast wave from the content provision server 6 and outputs to the content decrypting portion 207. Furthermore, the decrypting information receiving portion 202 receives the keys to be transmitted through the broadcast wave among the keys K₂ (K₃), . . . , Kₙ₋₁ (Kₙ), through the broadcast wave from the content provision server 6 and outputs received key data to the cipher key reproducing portion 206.

The basic key storage portion 205 is a data storing area for storing the basic key K₁ previously shared with the basic key management server 5. The basic key K₁ is transmitted from the basic key management server 5 through the communication network NW, and loaded in from a recording medium or via another terminal apparatus and then stored.

The cipher key reproducing portion 206 receives the encrypted mutual cipher keys K₁ (K₂) through Kₙ₋₂ (Kₙ₋₁) and the cipher key Kₙ₋₁ (Kₙ) from the decrypting information receiving portion 202 and the license information acquiring portion 204 and decrypts the mutual cipher key K₁ (K₂) with the basic key K₁ read out from the basic key storage portion 205, thereby reproducing a mutual cipher key K₂. Furthermore, the cipher key reproducing portion 206 decrypts the mutual cipher key K₂ (K₃) with the mutual cipher key K₂ to reproduce a mutual cipher key K₃. Thereafter, the cipher key reproducing portion 206 successively decrypts the mutual cipher keys K₃ (K₄), . . . , Kₙ₋₂ (Kₙ₋₁) and the cipher key Kₙ₋₁ (Kₙ) by mutually using the mutual cipher keys K₃, . . . , Kₙ₋₁, thereby acquiring a cipher key K. Then, the cipher key reproducing portion 206 outputs the reproduced cipher key Kₙ to the content decrypting portion 207. When the mutual cipher keys K₃ through Kₙ₋₁ and the cipher key Kₙ are converted using a conversion algorism, the cipher key reproducing portion 206 uses a corresponding conversion algorism to convert the mutual cipher keys K₃ through Kₙ₋₁ and the cipher key Kₙ. When converting, the cipher key reproducing portion 206 identifies the corresponding conversion algorism by referring to the additional information added to key data. Furthermore, when the additional information includes information for checking for falsification of a key that is used next, the cipher key reproducing portion 206 also performs processing of checking for falsification of key data.

The content decrypting portion 207 uses the reproduced cipher key Kₙ to decrypt the encrypted content Kₙ (C) and delivers obtained content Kₙ to an application program for music or video reproduction to reproduce the content. Here, when the content C is added with information about reproducing content, the content decrypting portion 207 extracts the information to deliver to the program to reproduce the content.

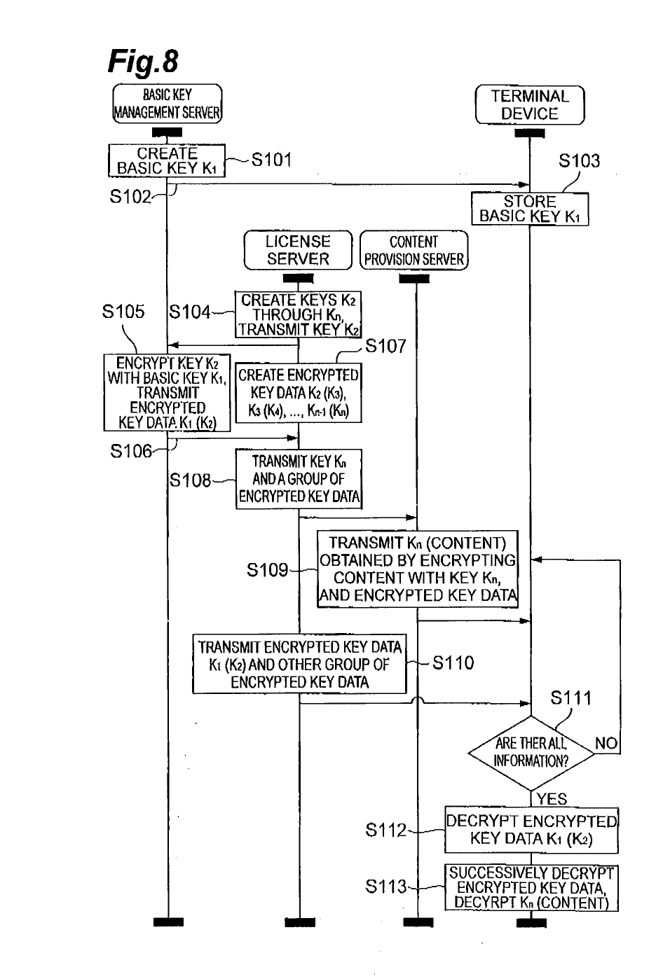

With reference to FIG. 8, operation of the content transmission system 1 will be described and also, a method for transmitting content in the content transmission system 1 will be described. FIG. 8 is a sequence diagram illustrating operation when content is transmitted in the content transmission system 1.

First, a basic key K₁ that the terminal apparatus 2 uses to receive provision of a broadcast service is created by the basic key management server 5 (step S101). Next, the created basic key K₁ is transmitted to the terminal apparatus 2 (step S102) and stored in the basic key storage portion 205 of the terminal apparatus 2 (step S103).

Then, after a cipher key Kₙ and mutual cipher keys K₂ through Kₙ₋₁ to reproduce the cipher key Kₙ are created by the license server 3, the mutual cipher key K₂ is transmitted to the basic key management server 5 (step S104). In response to that, the mutual cipher key K₂ is encrypted with the basic key K₁ by the basic key management server 5 (step S105) and created encrypted key data K₁ (K₂) is sent back to the license server 3 (step S106).

On the other hand, the remaining mutual cipher keys K₃ through Kₙ₋₁ and the cipher key Kₙ are encrypted by successively using respective mutual cipher keys K₂ through Kₙ₋₁ by the license server 3 and encrypted key data K₂ (K₃), . . . , Kₙ₋₁ (Kₙ) are created (step S107). Then, the cipher key Kₙ and the keys to be transmitted through a broadcast wave to the terminal apparatus 2 among the encrypted key data K₂ (K₃), . . . , Kₙ₋₁ (Kₙ) are transmitted from the license server 3 to the content provision server 6 (step S108). Meanwhile, the content C is encrypted with the cipher key Kₙ by the content provision server 6, and encrypted content Kₙ (C) and encrypted key data to be transmitted through the broadcast wave to the terminal apparatus 2 are transmitted through the broadcast wave to the terminal apparatus 2 (step S109). Furthermore, the encrypted key data K₁ (K₂) and keys to be transmitted through the communication network NW among the encrypted key data K₂ (K₃), . . . , and Kₙ₋₁ (Kₙ) are transmitted from the license server 3 to the terminal apparatus 2 (step S110).

Next, in the terminal apparatus 2, it is verified whether there are all of the encrypted key data K₁ (K₂), . . . , Kₙ₋₁ (Kₙ) (step S111). As a result of such verification, when there are all of the encrypted key data (step S111; Yes), the encrypted key data K₁ (K₂) is decrypted with the basic key K₁ (step S112). Thereafter, the encrypted key data K₂ (K₃), . . . , Kₙ₋₁ (Kₙ) are successively decrypted to reproduce the cipher key Kₙ and the encrypted content Kₙ (C) is decrypted with the cipher key Kₙ (step S113). Here, when the encrypted key data K₁ (K₂), . . . , Kₙ₋₁ (Kₙ) lack a part thereof, in order to avoid an endless loop of processing and no response, processing such as transmitting a resend request of a lacking part, suspending processing by using an operation timer and the like are performed in the terminal apparatus 2.

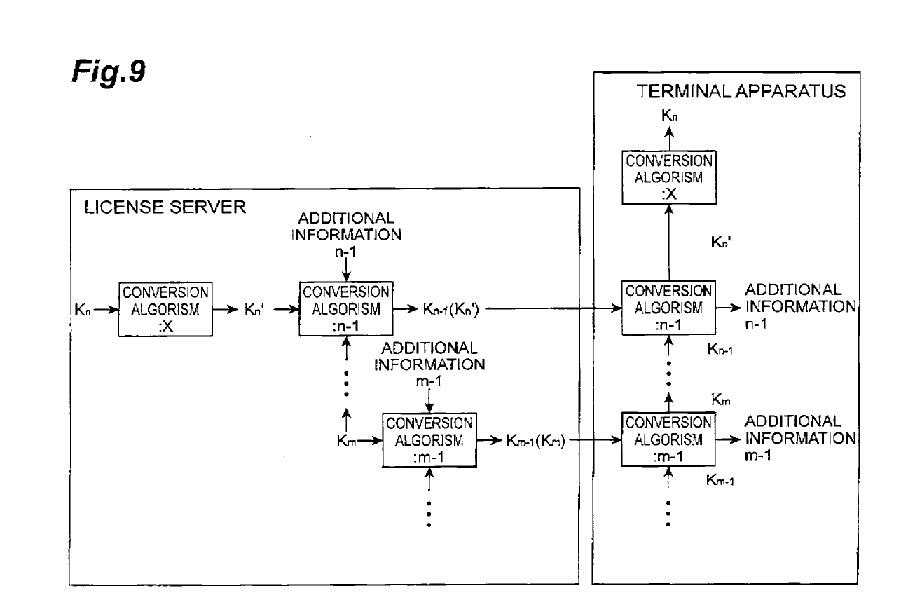

FIG. 9 is a conceptual diagram illustrating a flow of encrypting processing and decrypting processing of the cipher key Kₙ to encrypt content in the content transmission method described above. As illustrated in the figure, the cipher key Kₙ is converted using a conversion algorism X into a cipher key Kₙ′; the cipher key Kₙ′ thus converted is added with additional information n-1 including information to identify the conversion algorism X and encrypted with a cipher key Kₙ₋₁ converted using a conversion algorism n-1; and thereby, encrypted key data Kₙ₋₁ (Kₙ′) is created and transmitted to the terminal apparatus 2. Furthermore, a mutual cipher key Kₘ (m is an integer equal to or larger than two and equal to or less than n-1) is encrypted with a mutual cipher key Kₘ₋₁ converted using a conversion algorism m-1 and thereby, encrypted key data Kₘ₋₁ (Kₘ) is created and transmitted to the terminal apparatus 2.

By decrypting the transmitted encrypted key data Kₘ₋₁ (Kₘ) with the mutual cipher key Kₘ₋₁ that has been already decrypted and converted using the conversion algorism m-1, a mutual cipher key Kₘ and additional information m-1 are restored. Then, decryption is successively performed and encrypted key data Kₙ₋₁ (Kₙ′) is decrypted with a mutual decrypting key Kₙ₋₁ converted using the conversion algorism n-1 and thereby, a cipher key Kₙ′ and additional information n-1 are restored. Finally, the cipher key Kₙ′ is inverse-converted using the conversion algorism X identified using the additional information n-1 and thereby, a cipher key Kₙ is reproduced.

As described above, according to the content transmission system 1 and the content transmission method, a basic key K₁ is created by the basic key management server 5; a cipher key Kₙ and a plurality of mutual cipher keys K₂ through Kₙ₋₁ to reproduce the cipher key Kₙ are created by the license server 3; a mutual cipher key K₂ is encrypted with the basic key K₁ by the basic key management server 5; mutual cipher keys K₃ through Kₙ₋₁ and the cipher key Kₙ are encrypted by successively using K₂ through Kₙ₋₁ by the license server 3; encrypted content Kₙ (C) and one part of encrypted key data K₂ (K₃), . . . , Kₙ₋₁ (Kₙ) are transmitted to the terminal apparatus 2 by the content provision server 6; and encrypted key data K₁ (K₂) and the other part of the encrypted key data K₂ (K₃), . . . , Kₙ₋₁ (Kₙ) are transmitted to the terminal apparatus 2 by the license server 3. Thereby, data to reproduce a key to decrypt content is divided, encrypted and separately transmitted through the communication network and the broadcast network. A part thereof is encrypted with the basic key that is previously created and the remaining part thereof is encrypted by mutually using itself as a mutual cipher key, therefore, it is possible to reliably reduce the risk that key information is illegally acquired during transmission of data. That is, even when a part of data to reproduce a key is illegally acquired on a network or even when the terminal apparatus is illegally analyzed and the basic key that is previously created for provision of a broadcast service is illegally acquired; it is possible to prevent illegal use of an encrypted key to decrypt content. Furthermore, since direct transaction of the basic key and the key to decrypt the content is made unnecessary between the basic key management server 5 and the license server 3, even when communication between the basic key management server 5 and the license server 3 is hacked, it is possible to improve information security regarding the content.

Moreover, since the plurality of encrypted mutual cipher keys K₂ through Kₙ₋₁ and the cipher key Kₙ are divided and transmitted to the terminal apparatus 2 and while a part thereof is encrypted with the basic key K₁, and the remaining part thereof is mutually encrypted, even when a part of data to reproduce a key and the basic key previously created are illegally acquired, it is possible to prevent illegal use of an encrypted key to decrypt content. Furthermore, there is an advantage that while preventing illegal use of the content, processing to reproduce the cipher key does not become complicated.

The present invention is not limited to the embodiment described above. For example, in addition to creating a cipher key K_{z} to encrypt content C, the cipher key creating portion 301 may also create a plurality of divided cipher keys K₂ through Kₙ as a plurality of pieces of key reproduction data by dividing the cipher key K_{z}. In that case, the cipher key creating portion 301 outputs a divided cipher key K₂ among the plurality of created divided cipher keys K₂ through Kₙ to the key data transmitting portion 303 and outputs the mutual cipher keys K₂ through Kₙ to the key reproduction data encrypting portion 302. Here, the cipher key creating portion 301 may divide the cipher key K_{z} as it is to create the plurality of divided cipher keys K₂ through Kₙ or may make a division after performing a specified conversion.

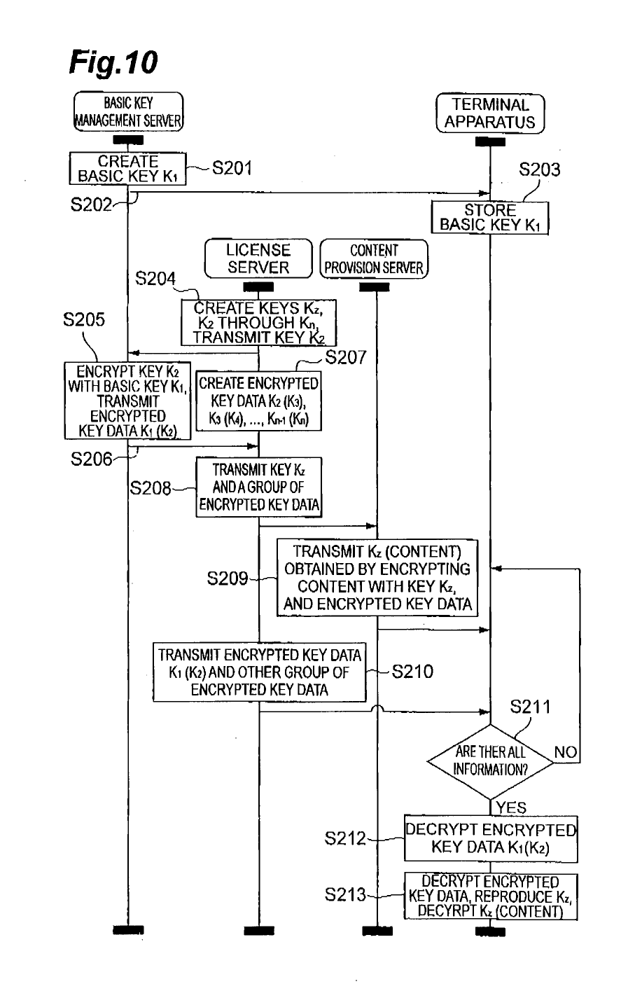

FIG. 10 illustrates a sequence diagram illustrating operation of the content transmission system 1 in that case.

First, in a similar way to processing of steps S101 through S103 illustrated in FIG. 8, a basic key K₁ is shared between the basic key management server 5 and the terminal apparatus 2 (steps S201 through S203). Then, a cipher key K_{z} and divided cipher keys K₂ through Kₙ to reproduce the cipher key K_{z} are created by the license server 3 and thereafter, the divided cipher key K₂ is transmitted to the basic key management server 5 (step S204). In response thereto, the divided cipher key K₂ is encrypted with the basic key K₁ by the basic key management server 5 (step S205) and created encrypted key data K₁ (K₂) is sent back to the license server 3 (step S206).

On the other hand, the remaining divided cipher keys K₃ through Kₙ are encrypted by successively using the respective divided cipher keys K₂ through Kₙ₋₁ by the license server 3 and encrypted key data K₂ (K₃), . . . , Kₙ₋₁ (Kₙ) are created (step S207). Then, the license server 3 transmits the cipher key K_{z} and keys to be transmitted through a broadcast wave to the terminal apparatus 2 among the encrypted key data K₂ (K₃), . . . , Kₙ₋₁ (Kₙ), to the content provision server 6 (step S208). Meanwhile, content C is encrypted with the cipher key K_{z} by the content provision server 6, and encrypted content K_{z} (C) and encrypted key data to be transmitted through the broadcast wave to the terminal apparatus 2 are transmitted through the broadcast wave to the terminal apparatus 2 (step S209). Furthermore, encrypted key data K₁ (K₂) and keys to be transmitted through the communication network NW among encrypted key data K₂ (K₃), . . . , Kₙ₋₁ (Kₙ) are sent from the license server 3 to the terminal apparatus 2 (step S210).

Next, in the terminal apparatus 2, it is verified whether there are all of the encrypted key data K₁ (K₂), . . . , Kₙ₋₁ (Kₙ) (step S211). As a result of such verification, when there are all of the encrypted key data (step S211; Yes), the encrypted key data K₁ (K₂) is decrypted with the basic key K₁ (step S212). Then, the encrypted key data K₂ (K₃), . . . , Kₙ₋₁ (Kₙ) are successively decrypted, so that all of the divided cipher keys K₂ through Kₙ are reproduced, and thereafter, the divided cipher keys K₂ through Kₙ are synthesized, so that the cipher key K_{Z} is reproduced, and the encrypted content Kₙ (C) are decrypted with the cipher key K_{z} (step S213).

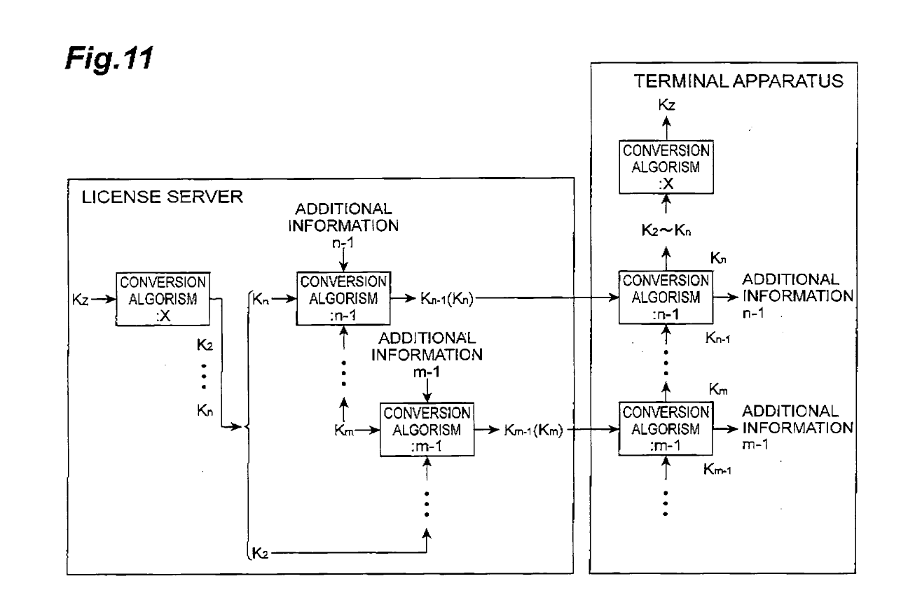

FIG. 11 is a conceptual diagram illustrating a flow of encrypting processing and decrypting processing of the cipher key K_{z} to encrypt content in the content transmission method described above. As illustrated in the figure, the cipher key Kₙ is converted using a conversion algorism X and divided, so divided cipher keys K₂ through Kₙ are created. The divided cipher key Kₙ among the divided cipher keys is added with additional information n-1 including information to identify a conversion algorism X and then, encrypted with the divided cipher key Kₙ₋₁ converted using a conversion algorism n-1, so that encrypted key data Kₙ₋₁ (Kₙ) is created and transmitted to the terminal apparatus 2. Furthermore, a divided cipher key Kₘ (m is an integer equal to or more than two and equal to or less than n-1) is encrypted with a divided cipher key Kₘ₋₁ converted using a conversion algorism m-1, so that encrypted key data Kₘ₋₁ (Kₘ) is created and transmitted to the terminal apparatus 2.

The transmitted encrypted key data Kₘ₋₁ (Kₘ) is decrypted with a divided cipher key Kₘ₋₁ that has been decrypted and converted using a conversion algorism m-1, so that a divided cipher key Kₘ and additional information m-1 is restored. Then, decryption is successively performed and the encrypted key data Kₙ₋₁ (Kₙ) is decrypted with a divided decrypted key Kₙ₋₁ converted using the conversion algorism n-1, so that a divided cipher key Kₙ and additional information n-1 are restored. Then, finally, key data synthesized with divided cipher keys K₂ through Kₙ are inverse-converted using the conversion algorism X specified by the additional information n-1, so that a cipher key K_{z} is reproduced.

In such a content transmission method, since a plurality of encrypted divided cipher keys K₂ through Kₙ are separately transmitted and while one part thereof is encrypted by the basic key K₁, and the remaining part thereof is mutually encrypted, even when a part of data to reproduce a key and the basic key previously created are illegally acquired, it is possible to prevent illegal use of a cipher key to decrypt content. Furthermore, since there is no direct transaction of the cipher key K_{z} to decrypt the content between the content transmission system 1 and the terminal apparatus 2, it is possible to further reduce the risk of illegal acquirement of the cipher key.

### INDUSTRIAL APPLICABILITY

The present invention is intended to be used for a key information management method, a content transmission method, a key information management apparatus, a license management apparatus, a content transmission system and a terminal apparatus; and makes it possible to reliably prevent illegal use of content, when the content encrypted with a cipher key is transmitted.

### REFERENCE SIGNS LIST

1 . . . content transmission system, 2 . . . terminal apparatus, 3 . . . license server (license management apparatus), 5 . . . basic key management server (basic key management apparatus), 6 . . . content provision server, 201 . . . content receiving portion (first receiving means), 202 . . . decrypting information receiving portion (first receiving means), 203 . . . data communicating portion (second receiving portion), 204 . . . license information acquiring portion (second receiving means), 206 . . . cipher key reproducing portion (key decrypting means), 207 . . . content decrypting portion (content decrypting means), 301 . . . cipher key creating portion (cipher key creating means), 302 . . . key reproduction data encrypting portion (key encrypting means), 306 . . . first data communicating portion (key information transmitting means), 501 . . . basic key creating portion (basic key creating means), 504 . . . key data encrypting portion (key encrypting means), 602 . . . content encrypting portion (content encrypting means), 603 . . . data communicating portion (content transmitting means), K₁ . . . basic key, K₂ through Kₙ₋₁ . . . mutual cipher key, divided cipher key (key reproduction data), Kₙ . . . divided cipher key, cipher key, K_{z} . . . cipher key, C . . . content

1. A key information management method for encrypting and transmitting content to a terminal apparatus, the key information management method comprising:
a basic key creating step of by basic key management means, creating a basic key; and
a key encrypting step of, by the basic key management means, encrypting with the basic key one piece of key reproduction data among a plurality of pieces of key reproduction data to reproduce a cipher key to encrypt the content.

2. A key information management method for encrypting and transmitting content to a terminal apparatus, the key information management method comprising:
a cipher key creating step of, by cipher key creating means, creating a cipher key to encrypt the content and also creating a plurality of pieces of key reproduction data to reproduce the cipher key;
a key encrypting step of, by the cipher key creating means, encrypting another piece of key reproduction data excluding one piece of key reproduction data among the plurality of pieces of key reproduction data by successively using the one piece of key reproduction data and the other piece of key reproduction data correspondingly; and
a transmitting step of, by the cipher key creating means, transmitting the one piece of key reproduction data encrypted with a specific basic key and one part of the other piece of key reproduction data encrypted at the key encrypting step to the terminal apparatus.

3. A content transmission method for encrypting and transmitting content to a terminal apparatus, the content transmission method comprising:
a basic key creating step of, by basic key management means, creating a basic key;
a cipher key creating step of, by cipher key creating means, creating a cipher key to encrypt the content and also creating a plurality of pieces of key reproduction data to reproduce the cipher key;
a first key encrypting step of, by the basic key management means, encrypting one piece of key reproduction data among the plurality of pieces of key reproduction data by the basic key;
a second key encrypting step of, by the cipher key creating means, encrypting another piece of key reproduction data excluding the one piece of key reproduction data among the plurality of pieces of key reproduction data by successively using the one piece of key reproduction data and the other piece of key reproduction data correspondingly;
a content encrypting step of, by content encrypting means, encrypting the content with the cipher key;
a first transmitting step of, by content transmitting means, transmitting the content that has been encrypted and one part among the one and the other pieces of encrypted key reproduction data to the terminal apparatus; and
a second transmitting step of, by the cipher key creating means, transmitting another part among the one and the other pieces of encrypted key reproduction data to the terminal apparatus.

4. The content transmission method according to claim 3, wherein
a plurality of mutual cipher keys are created as the plurality of pieces of key reproduction data at the cipher key creating step,
a first mutual cipher key among the plurality of mutual cipher keys is encrypted with the basic key at the first key encrypting step,
the cipher key and the plurality of mutual cipher keys excluding the first mutual cipher key are successively encrypted with the plurality of mutual cipher keys including the first mutual cipher key correspondingly at the second key encrypting step,
the content that has been encrypted and one part among the plurality of encrypted mutual cipher keys and the cipher key are transmitted to the terminal apparatus at the first transmitting step, and
another part among the plurality of encrypted mutual cipher keys and the cipher key are transmitted to the terminal apparatus at the second transmitting step.

5. The content transmission method according to claim 3, wherein
the cipher key is divided, so that a plurality of divided cipher keys are created as the plurality of pieces of key reproduction data at the cipher key creating step,
a first divided cipher key among the plurality of divided cipher keys is encrypted with the basic key at the first key encrypting step,
the plurality of divided cipher keys excluding the first divided cipher key are successively encrypted with the plurality of divided cipher keys including the first divided cipher key at the second key encrypting step,
the content that has been encrypted and one part of the plurality of encrypted divided cipher keys are transmitted to the terminal apparatus at the first transmitting step, and
another part of the plurality of encrypted divided cipher keys is transmitted to the terminal apparatus at the second transmitting step.

6. A basic key management apparatus for encrypting and transmitting content to a terminal apparatus, the basic key management apparatus comprising:
basic key creating means for creating a basic key; and
key encrypting means for encrypting one piece of key reproduction data among a plurality of pieces of key reproduction data to reproduce a cipher key to encrypt the content with the basic key.

7. A license management apparatus for encrypting and transmitting content to a terminal apparatus, the license management apparatus comprising:
cipher key creating means for creating a cipher key to encrypt the content and also creating a plurality of pieces of key reproduction data to reproduce the cipher key;
key encrypting means for encrypting another piece of key reproduction data excluding one piece of key reproduction data among the plurality of pieces of key reproduction data by successively using the one piece of key reproduction data and the other piece of key reproduction data correspondingly; and
transmitting means for transmitting the one piece of key reproduction data encrypted with a specific basic key and one part of the other piece of key reproduction data encrypted by the key encrypting means to the terminal apparatus.

8. A content transmission system for encrypting and transmitting content to a terminal apparatus, the content transmission system comprising:
basic key creating means for creating a basic key;
cipher key creating means for creating a cipher key to encrypt the content and also creating a plurality of pieces of key reproduction data to reproduce the cipher key;
first key encrypting means for encrypting one piece of key reproduction data among the plurality of pieces of key reproduction data with the basic key;
second key encrypting means for encrypting another piece of key reproduction data excluding the one piece of key reproduction data among the plurality of pieces of key reproduction data by successively using the one piece of key reproduction data and the other piece of key reproduction data correspondingly;
content encrypting means for encrypting the content with the cipher key;
content transmission means for transmitting the content that has been encrypted and one part among the one and the other pieces of encrypted key reproduction data to the terminal apparatus; and
key information transmitting means for transmitting another part among the one and the other pieces of encrypted key reproduction data to the terminal apparatus.

9. A terminal apparatus for receiving and decrypting encrypted content, the terminal apparatus comprising:
first receiving means for receiving the content that has been encrypted with a cipher key and one part of key reproduction data among a plurality of pieces of encrypted key reproduction data;
second receiving means for receiving another part of key reproduction data among the plurality of pieces of encrypted key reproduction data;
key decrypting means for reproducing the cipher key by decrypting one piece of key reproduction data among the plurality of pieces of encrypted key reproduction data with a basic key and, thereafter, by successively decoding the plurality of pieces of key reproduction data excluding the one piece of key reproduction data mutually using the plurality of pieces of key reproduction data, and
content decrypting means for decrypting the content using the cipher key.
